(19) United States
(12) Patent Application Publication
(10) Pub. No.: US 2021/0097556 A1
(43) Pub. Date: Apr. 1, 2021

(54) DATA PROCESSING

(71) Applicant: Beijing Sensetime Technology Development Co., Ltd., Beijing (CN)

(72) Inventors: Chen CHEN, Beijing (CN); Yuting GAO, Beijing (CN)

(21) Appl. No.: 17/122,216

(22) Filed: Dec. 15, 2020

Related U.S. Application Data
(63) Continuation of application No. PCT/CN2020/102872, filed on Jul. 17, 2020.

(30) Foreign Application Priority Data
Aug. 14, 2019 (CN) 201910751054.4

(51) Int. Cl. G06Q 30/02; G06K 9/00

(52) U.S. Cl. CPC G06Q 30/0201; G06K 9/00362; G06K 9/00718

(57) ABSTRACT

The embodiments of the present disclosure provide data processing methods, apparatuses and storage media. One of the methods includes: determining total stay time corresponding to a plurality of captured images involving a target person visited within a preset time range; determining a popularity ranking result for the plurality of vehicle models based on the total stay time for each of the plurality of vehicle models; and sending the popularity ranking result for the plurality of vehicle models to a terminal.

### CROSS-REFERENCE TO RELATED APPLICATIONS

This application is a continuation application of International Patent Application No. PCT/CN2020/102872 filed with the China National Intellectual Property Administration (CNIPA) on Jul. 17, 2020, which is based on and claims priority to and benefit of Chinese Patent Application No. 201910751054.4, filed with the CNIPA on Aug. 14, 2019. The contents of all of the above-identified applications are incorporated herein by reference in their entirety.

### TECHNICAL FIELD

The present disclosure relates to the field of computer vision, and in particular to data processing methods, apparatuses and storage media.

### BACKGROUND

In the actual operation of a 4S (Sale, Sparepart, Service, Survey) store, the sales staff can learn the interest of an individual customer on vehicle models through reception and customer follow-up work, but there is no effective solution for learning the interests of a group of customers on each of the vehicle models.

### SUMMARY

The embodiments of the present disclosure provide technical solutions of data processing methods.

From a first aspect, an embodiment of the present disclosure provides a data processing method applied to a server. The method includes: determining a total stay time for each of a plurality of vehicle models based on captured images involving a plurality of target persons visited within a preset time range; determining a popularity ranking result for the plurality of vehicle models based on the total stay time for each of the plurality of vehicle models; and sending the popularity ranking result for the plurality of vehicle models to a terminal.

In an embodiment, the method further includes: for each of the target persons, determining an interested vehicle model based on stay time information on the target person for the plurality of vehicle models.

In an embodiment, wherein determining the total stay time corresponding for each of the plurality of vehicle models includes: based on location information on a target person which is involved in the captured images and location information on one or more vehicle model areas which are preset for each of the plurality of vehicle models, determining a vehicle model area where the target person stay; and based on a capturing timing of each of the captured images and the vehicles model areas where the target person involved in the captured images stays, determining a stay time of the target person for each of the plurality of vehicle models.

In an embodiment, determining the total stay time for each of the plurality of vehicle models includes: in response to that adjacent appearances of the target persons correspond to a same vehicle model area and a time difference between the adjacent appearances is less than or equal to a preset time threshold, counting the time difference between the adjacent appearances into stay time of the target persons for the corresponding vehicle model area.

In an embodiment, determining the total stay time for each of the plurality of vehicle models includes: in response to that a time difference between adjacent appearances of the target persons is greater than a preset time threshold, determining not to count the time difference between the adjacent appearances into stay time of the target persons for the corresponding vehicle model area.

In an embodiment, determining the total stay time for each of the plurality of vehicle models based on captured images involving a plurality of target persons visited within the preset time range includes: configuring an independent accumulator for the vehicle model area; accumulating, at a preset time period and by the accumulator, a stay time of target persons appeared in the vehicle model area, so as to obtain an accumulated stay time of the vehicle model area in the preset time period; and obtaining a total stay time for the vehicle model area by summing up the accumulated stay time of the vehicle model area in at least one the preset time period within the preset time range.

In an embodiment, the method further includes: in response to that the preset time period is expired, resetting the accumulator.

In an embodiment, the method further includes: receiving, from the terminal, a first query condition which at least comprises the preset time range; and determining the total stay time for each of the plurality of vehicle models based on captured images involving a plurality of target persons visited within the preset time range includes: in response to the first query condition, determining the total stay time for each of the plurality of vehicle models based on captured images involving a plurality of target persons visited within the preset time range.

From a second aspect, an embodiment of the present disclosure provides a data processing method applied to a terminal. The method includes: receiving a popularity ranking result for a plurality of vehicle models from a server; and displaying the popularity ranking result for the plurality of vehicle models; wherein a popularity of each of the vehicle models is obtained by the server based on a total stay time for each of the plurality of vehicle models within a preset time range.

In an embodiment, the method further includes: receiving a first query condition which at least comprises the preset time range; and sending the first query condition to the server.

From a third aspect, an embodiment of the present disclosure provides a data processing apparatus including: a first determining module, configured to determine total stay time for each of a plurality of vehicle models based on captured images involving a plurality of target persons visited within a preset time range; a second determining module, configured to determine a popularity ranking result for the plurality of vehicle models based on the total stay time for each of the plurality of vehicle models; and a sending and processing module, configured to send the popularity ranking result for the plurality of vehicle models to a terminal.

In an embodiment, the apparatus further includes: a third determining module, configured to, for each of the target persons, determine an interested vehicle model based on stay time information on the target person for the plurality of vehicle models.

In an embodiment, the second determining module is configured to: based on location information on a target person which is involved in the captured images and location information on one or more vehicle model areas which are preset for each of the plurality of vehicle models, determine a vehicle model area where the target person stay; based on a capturing timing of each of the captured images and the vehicles model areas where the target person involved in the captured images stays, determine a stay time of the target person for each of the plurality of vehicle models.

In an embodiment, the second determining module is configured to: in response to that adjacent appearances of the target persons correspond to a same vehicle model area and a time difference between the adjacent appearances is less than or equal to a preset time threshold, count the time difference between the adjacent appearances into stay time of the target persons for the corresponding vehicle model area.

In an embodiment, the second determining module is configured to: in response to that a time difference between adjacent appearances of the target persons is greater than a preset time threshold, determine not to count the time difference between the adjacent appearances into stay time of the target persons for the corresponding vehicle model area.

In an embodiment, the second determining module includes: a configuring unit, configured to for each of a plurality of vehicle model areas corresponding to the plurality of vehicle models, configure an independent accumulator for the vehicle model area; a controlling unit, configured to accumulate at a preset time period and by the accumulator, a stay time of target persons appeared in the vehicle model area, so as to obtain an accumulated stay time of the vehicle model area in the preset time period; a determining unit, configured to obtain a total stay time for the vehicle model area by summing up the accumulated stay time of the vehicle model area in at least one the preset time period within the preset time range.

In an embodiment, the controlling unit is further configured to: in response to that the preset time period is expired, reset the accumulator.

In an embodiment, the apparatus further includes: a receiving and processing module, configured to receive from the terminal, a first query condition which at least comprises the preset time range; and the second determining module is further configured to: in response to the first query condition, determine the total stay time for each of the plurality of vehicle models based on captured images involving a plurality of target persons visited within the preset time range.

From a fourth aspect, an embodiment of the present disclosure provides a data processing apparatus applied in a terminal. The apparatus includes: a communication module, configured to receive a popularity ranking result for a plurality of vehicle models from a server; and a displaying and processing module configured to display the popularity ranking result for the plurality of vehicle models; wherein a popularity of each of the vehicle models is obtained by the server based on a total stay time for each of the plurality of vehicle models within a preset time range.

In an embodiment, the apparatus further includes: an input module, configured to receive a first query condition which at least comprises the preset time range; wherein the communication module is further configured to send the first query condition to the server.

From a fifth aspect, an embodiment of the present disclosure provides a data processing apparatus including: a memory, a processor and computer program stored on the memory and executable by the processor, when the program is executed by the processor, the processor implements the steps of the data processing methods applied to the server side provided in the embodiments of the present disclosure.

From a sixth aspect, an embodiment of the present disclosure provides a storage medium storing computer program, when the computer program is executed by a processor, the processor implements the steps of the data processing methods applied to the server side provided in the embodiments of the present disclosure.

From a seventh aspect, an embodiment of the present disclosure provides a data processing apparatus including: a memory, a processor and computer program stored on the memory and executable by the processor, when the program is executed by the processor, the processor implements the steps of the data processing methods applied to the terminal side provided in the embodiments of the present disclosure.

From an eighth aspect, an embodiment of the present disclosure provides a storage medium storing computer program, when the computer program is executed by a processor, the processor implements the steps of the data processing methods applied to the terminal side provided in the embodiments of the present disclosure.

From a ninth aspect, an embodiment of the present disclosure provides a computer program including computer readable code, when the computer readable code is run in an electronic device, a processor in the electronic device implements the data processing methods provided in the embodiments of the present disclosure.

In the technical solution of the embodiments of the present disclosure, a total stay time for each of a plurality of vehicle models is determined based on captured images involving a plurality of target persons visited within a preset time range; a popularity ranking result for the plurality of vehicle models is determined based on the total stay time for each of the plurality of vehicle models; and the popularity ranking result for the plurality of vehicle models is sent to a terminal. As such, by determining the popularity ranking of the vehicle models based on a stay time of each of target persons in one or more vehicle model areas, the staff may perform targeted works and offer services based on the popularity of the vehicle models and the customer experience and sales conversion rate may be improved.

It should be understood that the above general description and the following detailed description are only exemplary and explanatory, rather than limiting the present disclosure.

### BRIEF DESCRIPTION OF THE DRAWINGS

The drawings herein are incorporated into the specification and constitute a part of the specification. These drawings illustrate embodiments that conform to the disclosure, and are used together with the specification to explain the technical solutions of the disclosure.

With reference to the drawings, the application can be understood more clearly according to the following detailed description.

FIG. 1 is a first flowchart for implementing a data processing method provided by some embodiments of the present disclosure.

FIG. 2 is a second flowchart for implementing a data processing method provided by some embodiments of the present disclosure.

FIG. 3 illustrates schematically an interface of displaying vehicle model popularity provided by some embodiments of the present disclosure.

FIG. 4 illustrates a first schematic structure of a data processing apparatus provided by some embodiments of the present disclosure.

FIG. 5 illustrates a second schematic structure of a data processing apparatus provided by some embodiments of the present disclosure.

FIG. 6 is a block diagram of an apparatus for implementing the data processing provided by some embodiments of the present disclosure.

### DETAILED DESCRIPTION OF THE EMBODIMENTS

Various exemplary embodiments, features, and aspects of the present disclosure will be described in detail below with reference to the accompanying drawings. Like reference signs in the drawings denote functionally identical or similar elements. Although various aspects of the embodiments are shown in the drawings, the drawings need not be drawn to scale unless specifically noted.

The word “exemplary” as used herein means “serving as an example, embodiment, or illustration”. Any embodiment described herein as “exemplary” is not necessarily to be construed as being superior to or better than other embodiments.

The term “and/or” herein is merely an association relationship describing an associated object, and indicates that there may be three relationships, for example, a and/or b, and may indicate that there are three cases: a alone, a and b alone, and b alone In addition, the term ‘at least one’ herein denotes any combination of at least two of any one or more of a plurality of, for example, including at least one of a, b, c, and may denote any one or more elements selected from the set consisting of a, b, and c.

In addition, in order to better illustrate embodiments of the present disclosure, numerous specific details are given in the following detailed description. It should be understood by those skilled in the art that the embodiments of the present disclosure may be equally implemented without certain specific details. In some examples, methods, means, elements, and circuitry well known to those skilled in the art are not described in detail in order to highlight the subject matter of embodiments of the present disclosure.

It is understandable that the above method embodiments mentioned in the present disclosure can all be combined with each other to form a combined embodiment without violating the principle logic, which is limited to the same one, and the embodiments of the present disclosure are not described herein again.

In order to make those skilled in the art better understand the embodiments of the present application, the technical solutions in the embodiments of the present disclosure will be clearly described below with reference to the accompanying drawings in the embodiments of the present application. Apparently, the embodiments described are merely some embodiments of the present application, rather than all embodiments.

The terms “first,” “second,” and “third,” etc. in the embodiments and claims of the description of the present application and the figures above, are used to distinguish similar objects, and need not be used to describe a particular order or sequence. Moreover, the terms “comprising” and “having” and any variation thereof, are intended to cover an exclusive inclusion, e. g., comprising a series of steps or units. The methods, systems, products or apparatuses need not be limited to those steps or units set forth clearly, but may include other steps or units not set forth clearly or inherent to these processes, methods, products or apparatuses.

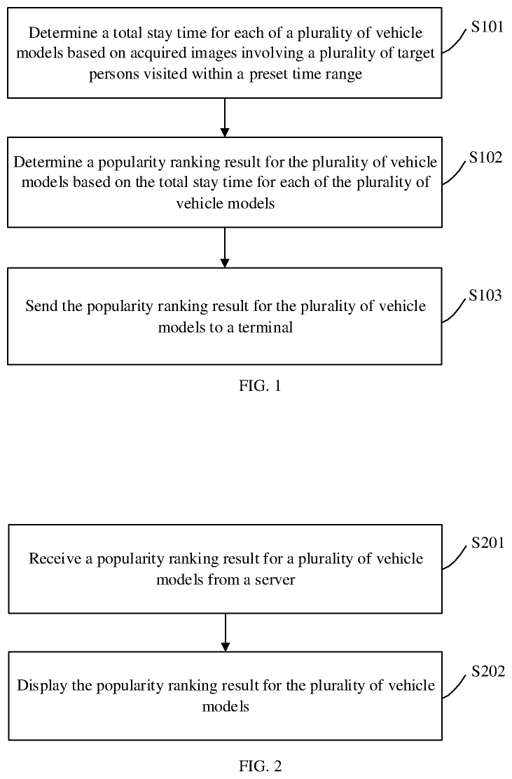

The embodiments of the present disclosure provide a data processing method applied to a server side, where the server may be a cloud server or a common server; the data processing method may also be applied to an electronic device, where the electronic device may be a user equipment (UE), a mobile device, a user terminal, a cellular phone, a cordless phone, a personal digital assistant (PDA), a handheld device, a computing device, an vehicle-mounted device, a wearable device, etc. As shown in FIG. 1, the method includes:

At step 101, a total stay time for each of a plurality of vehicle models is determined based on captured images involving a plurality of target persons visited within a preset time range.

The total stay time for each of the plurality of vehicle models refers to a total stay time for each of the plurality of vehicle models. The total stay time for different vehicle models may be different.

For example, an accumulated stay time for vehicle model 1 in a first preset time period is t1, an accumulated stay time in a second preset time period is t2, and an accumulated stay time in a third preset time period is t3. Thus, within the preset time range, the total stay time for vehicle model 1 is t1+t2+t3. An accumulated stay time for vehicle model 2 in the first preset time period is t1′, an accumulated stay time in the second preset time period is t2′, and an accumulated stay time in the third preset time period is t3′. Thus, within the preset time range, the total stay time for vehicle model 2 is t1′+t2′+t3′.

Longer the total stay time of a vehicle model, greater the popularity of the vehicle model; shorter the total stay time of the vehicle model, lower the popularity of the vehicle model.

It is understandable that the target person does not include people who are on a whitelist.

The whitelist usually refers to people who may not have an impact on the popularity of the vehicle model or have a negligible impact, for example, people who have no purchase demand or low purchase demand. The whitelist includes at least one of the following: a staff of the 4S store, a cleaning staff, a maintenance staff, a courier staff, a food delivery staff.

It should be noted that people in the whitelist can be set or adjusted according to user requirements.

In an optional embodiment, upon identifying the captured images of an image capturing device, whether a currently identified object belongs to the whitelist is first determined. If the currently identified object belongs to the whitelist, the currently identified object is ignored; the currently identified object does not belong to the whitelist, the currently identified object is determined to be a target person and the stay time of the target person on the plurality of vehicle models is analyzed.

In some embodiments, determining the total stay time for each of the plurality of vehicle models includes:

based on location information on a target person which is involved in the captured images and location information on one or more vehicle model areas which are preset for each of the plurality of vehicle models, determining a vehicle model area where the target person stay; and

based on a capturing timing of each of the captured images and the vehicles model areas where the target person involved in the captured images stays, determining a stay time of the target person for each of the plurality of vehicle models.

Here, the area where the preset vehicle model area is located is greater than or equal to the area occupied by a single vehicle, and the preset vehicle model area may be delineated automatically by a system or manually by a person. In practical applications, each preset vehicle model area can have an independent number, and each vehicle model can correspond to one or more preset vehicle model areas.

It should be noted that a corresponding relationship between the vehicle model and the vehicle model area can be determined based on a manual setting by a user. The corresponding relationship between the vehicle model and the vehicle model area can also be determined based on an automatic setting of the system, for example, based on the shape and identification of the vehicle. For example, each vehicle model corresponds to a vehicle model area. For example, Haval H6 model is presented in vehicle model area 1, Haval H7 model is presented in vehicle model area 2, Haval M6 model is presented in vehicle model area 3, and Haval F7 model is presented in vehicle model area 4.

For another example, a same vehicle model can correspond to one or more vehicle model areas. For example, the Haval H6 model is presented in vehicle model areas 1 and 2, the Haval H7 model is presented in vehicle model areas 3 and 4, the Haval M6 model is presented in vehicle model area 5, and the Haval F7 model is presented in vehicle model area 6.

In some embodiments, the relationship between the vehicle model and the model area may be predetermined. For example, the relationship between the vehicle model and the model area can be set by the user, or the relationship between the vehicle model and the model area can be determined based on the location of the vehicle.

In some embodiments, determining the total stay time for each of the plurality of vehicle models includes:

in response to that adjacent appearances of the target persons correspond to a same vehicle model area and a time difference between the adjacent appearances is less than or equal to a preset time threshold, counting the time difference between the adjacent appearances into stay time of the target persons for the corresponding vehicle model area.

In some embodiments, determining the total stay time for each of the plurality of vehicle models includes:

in response to that a time difference between adjacent appearances of the target persons is greater than a preset time threshold, determining not to count the time difference between the adjacent appearances into stay time of the target persons for the corresponding vehicle model area.

It should be noted that the preset time threshold can be set or adjusted according to actual conditions or user requirements.

For example, assuming that the preset time threshold is 5 minutes, a front-end server responsible for image acquisition and image identification processing sends a message to a back-end server responsible for vehicle model analysis every one minute. The message contains time information and location information on each of the target persons; the back-end server receives a message of visit information on target person A, and the message specifically indicates that target person A appeared in a first vehicle model area at 9:00; at the 7th minute, the back-end server receives visit information on the target person A and the visit information specifically indicates that target person A appeared in the first vehicle model area at 9:07; and at the 2nd, 3rd, 4th, 5th, and 6th minute, the background server does not receive the message related to target person A, then, the background server determines that the image of target person A is actually captured at a moment, and does not record the stay time of target person A.

For example, assuming that at the first minute, the back-end server receives visit information on target person B, and the visit information specifically indicates that the target person B appeared in the first vehicle model area at 9:01; at the second minute, the back-end server receives the visit information on target person B, and the visit information specifically indicates that target person B appeared in the second vehicle model area at 9:02, and at the 3rd, 4th, 5th, 6th, and 7th minute, the background server does not receive the message related to target person B, then the background server determines that target person B has actually left, and does not record the stay time of target person B.

For example, assuming that at the first minute, the back-end server receives the visit information on target person C, and the visit information specifically indicates that the target person C appeared in the first vehicle model area at 9:01; at the second minute, the back-end server receives the visit information on target person C, and the visit information specifically indicates that target person C appeared in the first vehicle model area at 9:02, and at the 3rd, 4th, 5th, 6th, and 7th minute, the background server does not receive the message related to target person C, then the background server determines that the stay time of target person C in the first vehicle model area is one minute.

As such, by setting a preset time threshold to determine the stay time of each of the target persons on the vehicle models, a more reasonable and accurate data basis is provided for determining the interests of the target persons on vehicle models.

In some embodiments, determining the total stay time for each of the plurality of vehicle models based on captured images involving a plurality of target persons visited within the preset time range includes:

for each of a plurality of vehicle model areas corresponding to the plurality of vehicle models, configuring an independent accumulator for the vehicle model area;

accumulating, at a preset time period and by the accumulator, a stay time of target persons appeared in the vehicle model area, so as to obtain an accumulated stay time of the vehicle model area in the preset time period; and

obtaining a total stay time for the vehicle model area by summing up the accumulated stay time of the vehicle model area in at least one the preset time period within the preset time range.

Moreover, the method further includes:

in response to that the preset time period is expired, resetting the accumulator.

It should be noted that the preset time period can be set or adjusted according to user requirements.

In order to ensure the real-time performance of the data, take the preset time period as one day as an example, each vehicle model has an independent accumulator for each day. At the end of the day, the accumulated value in the accumulator is stored and then the accumulator is reset to count the stay time of the target person at the next day.

For example, the preset time range includes three preset time periods. The accumulated stay time for the first vehicle model area within the first preset time period is t1, and the accumulated stay time for the first vehicle model area within the second preset time period is t2, and the accumulated stay time for the first vehicle model area within the third preset time period is t3. Then, within the preset time range, a sum of the accumulated stay time for the first vehicle model area is t1+t2+t3.

At step S102, a popularity ranking result for the plurality of vehicle models is determined based on the total stay time for each of the plurality of vehicle models.

In some embodiments, determining the popularity ranking result for the plurality of vehicle models based on the total stay time for each of the plurality of vehicle models includes:

comparing the total stay time for each of the plurality of vehicle models; and

determining the popularity ranking result for the plurality of vehicle models based on a result of the comparison.

As such, by comparing the total stay time for each of the plurality of vehicle models, the popularities of the plurality of vehicle models are determined.

Longer the total stay time of a vehicle model, greater the popularity of a vehicle model; and shorter the total stay time of the vehicle model, lower the popularity of the vehicle model.

At step S103, the popularity ranking result for the plurality of vehicle models is sent to a terminal.

In an embodiment, the method further includes:

receiving a first query condition sent by the terminal, where the first query condition at least includes the preset time range; and

determining the total stay time for each of the plurality of vehicle models based on captured images involving a plurality of target persons visited within the preset time range includes:

in response to the first query condition, determining the total stay time for each of the plurality of vehicle models based on captured images involving a plurality of target persons visited within the preset time range.

In this way, the terminal can be provided with a query service, and the terminal can be provided with the popularity of the vehicle models within a certain time range, so that the staff may make work plan based on the popularity of the vehicle models to improve customer experience and sales conversion rate.

In some embodiments, the method further includes:

for each of the target persons, determining an interested vehicle model based on stay time information on the target person for the plurality of vehicle models.

As such, by determining the interested vehicle model of a single target person, the sales staff may be able to provide targeted service to the target person when the target person visits next time, and the experience of the target person and sales conversion rate may be improved.

In the technical solution of the embodiments, a total stay time for each of the plurality of vehicle models is determined based on captured images involving a plurality of target persons visited within a preset time range; a popularity ranking result for the plurality for vehicle models is determined based on the total stay time for each of the plurality of vehicle models; and the popularity ranking result for the plurality of vehicle models is sent to a terminal. As such, by determining the popularity ranking of the vehicle models based on the stay time of the target persons in the vehicle model area, the staff may perform targeted works and offer services based on the popularity of the vehicle models, and the customer experience and sales conversion rate may be improved.

The embodiments of the present disclosure provide a data processing method, which is applicable to a terminal, and the terminal may be a user equipment (UE), a mobile device, a user terminal, a cellular phone, a cordless phone, or a personal digital processor (PDA), a handheld device, a computing device, a vehicle-mounted device, a wearable device, etc. The terminal is used to query and receive a popularity ranking result for a plurality of vehicle models. As shown in FIG. 2, the method includes:

At step S201, a popularity ranking result for a plurality of vehicle models is received from a server.

A popularity of each of the vehicle models is obtained by the server based on total stay time for each of the plurality of vehicle models within a preset time range.

At step S202, the popularity ranking result for the plurality of vehicle models is displayed.

In some embodiments, the method further includes:

receiving a first query condition which at least includes the preset time range; and

sending the first query condition to the server.

after the server receives the first query condition from the terminal, in response to the first query condition, determining the total stay time for each of the plurality of vehicle models based on captured images involving a plurality of target persons visited within a preset time range.

As such, the popularity ranking of the vehicle models matched with the query condition may be provided to the terminal, so that the staff may be able to perform targeted works and offer services based on the popularity of the vehicle models and the customer experience and sales conversion rate may be improved.

In an embodiment, the method further includes:

receiving a second query condition which at least includes an identification of a first target person; and

sending the second query condition to the server to determine, by the server, an interested vehicle model of the first target person according to the second query condition.

For example, the identification may be an ID card number, a mobile phone number, a WeChat ID, etc.

For example, the identification may also be an image containing a facial feature or a body feature of the first target person.

Moreover, the method further includes:

receiving the interested vehicle model of the first target person from the server; and

displaying the interested vehicle model of the first target person.

As such, the terminal can query the interested vehicle model of a single target person, which is convenient for the sales staff to provide targeted services to the target person according to the interested vehicle model of the target person, and thereby improving the experience of the target person and sales conversion rate.

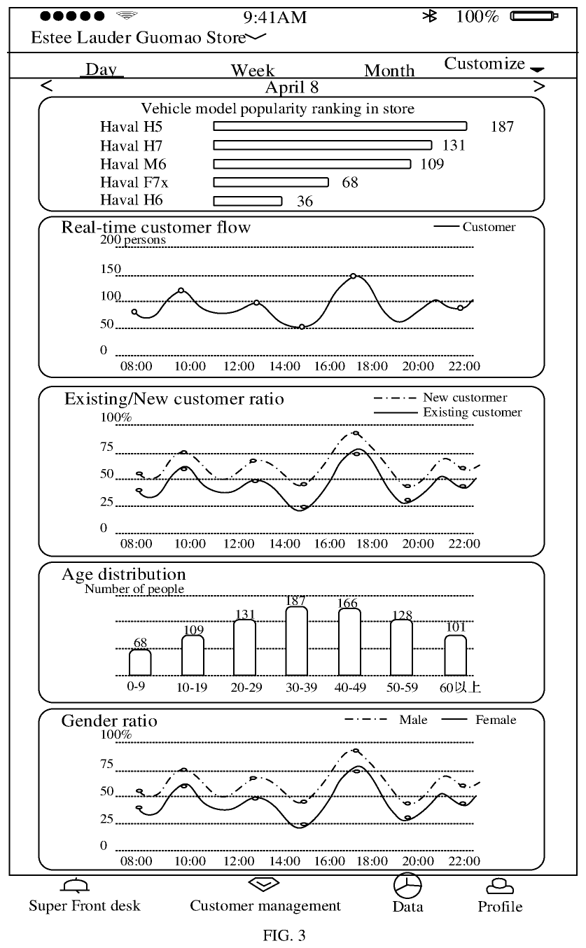

FIG. 3 shows a vehicle model popularity interface. As shown in FIG. 3, the interface displays a popularity ranking for the vehicle models in the store. A number of real-time customer flow, existing and new customer ratio, age distribution, and gender ratio are also displayed on the interface.

A method of calculating the stay time for a same vehicle model includes:

calculating the stay time of all target persons in each vehicle model area within a preset time period, and accumulating the stay time for a same vehicle model area.

In order to ensure the real-time performance of the data, the implementation of stream data processing is adopted. Each vehicle model has an independent stay time accumulator for each day, and the accumulator is reset at the end of the day.

In practical applications, the terminal receives a query condition as a time range of a certain historical day D1, and the server finds out the stay time for each vehicle model on D1 from the database based on the query condition, and ranks the stay time to obtain the popularity ranking for the vehicle models;

In practical applications, the terminal receives a query condition as a time range of a current day D-Current, and the server finds out the stay time for each vehicle model on D-Current from the accumulator based on the query condition, and ranks the stay time to obtain the popularity ranking for the vehicle models;

In practical applications, the terminal receives a query condition as a time range of a time period D1˜D2, and the server finds out the stay time for each vehicle model during D1˜D2 from the database or accumulator based on the query condition, then groups the stay time according to vehicle models and accumulates the stay time for each of the vehicle models to obtain a total stay time for the vehicle model, and ranks total stay time for the vehicle models to obtain the popularity ranking for the vehicle models; and

Through the interface, a 4S store sales staff and the store can detect the interests and popularity for the target persons in the store on each vehicle model, and combine with the model promotion needs and marketing strategies of the store to provide data support for the placement of vehicle models in the 4S store and feedback on marketing activities. Especially for regional companies, dealers and main engine plants, they can remotely know the level of interest for a group of target persons on each vehicle model in each store, so as to support operational decision-making and evaluation work efficiency for the sales staff/store.

It should be understood that the interface shown in FIG. 3 is an optional implementation, but is not limited thereto.

It should also be understood that the interface shown in FIG. 3 is only for exemplifying the embodiments of the present disclosure, and those skilled in the art can make various obvious changes and/or substitutions based on the example of FIG. 3, and the obtained technical solution still belongs to the scope of the embodiments of the present disclosure.

Corresponding to the foregoing data processing method, an embodiment of the present disclosure provides a data processing apparatus. As shown in FIG. 4, the apparatus includes:

a first determining module 10, configured to determine a total stay time for each of a plurality of vehicle models based on captured images involving a plurality of target persons visited within a preset time range;

a second determining module 20, configured to determine a popularity ranking result for the plurality of vehicle models based on the total stay time for each of the plurality of vehicle models; and

a sending and processing module 30, configured to send the popularity ranking result for the plurality of vehicle models to a terminal.

In an embodiment, the apparatus further includes:

a third determining module 40, configured to, for each of the target persons, determine an interested vehicle model based on stay time information on the target person for the plurality of vehicle models.

In some embodiments, the second determining model 20 is configured to:

based on location information on a target person which is involved in the captured images and location information on one or more vehicle model areas which are preset for each of the plurality of vehicle models, determine a vehicle model area where the target person stay; and

based on a capturing timing of each of the captured images and the vehicles model areas where the target person involved in the captured images stays, determining a stay time of the target person for each of the plurality of vehicle models.

In some embodiments, the second determining model 20 is configured to:

in response to that adjacent appearances of the target persons correspond to a same vehicle model area and a time difference between the adjacent appearances is less than or equal to a preset time threshold, count the time difference between the adjacent appearances into stay time of the target persons for the corresponding vehicle model area.

In some embodiments, the second determining model 20 is configured to:

in response to that a time difference between the adjacent appearances is greater than the preset time threshold, determine not to count the time difference between the adjacent appearances into the stay time of the target person for the corresponding vehicle model area.

In some embodiments, the second determining model 20 includes:

a configuring unit, configured to for each of a plurality of vehicle model areas corresponding to the plurality of vehicle models, configure an independent accumulator for the vehicle model area;

a controlling unit, configured to accumulate at a preset time period and by the accumulator, a stay time of target persons appeared in the vehicle model area, so as to obtain an accumulated stay time of the vehicle model area in the preset time period; and

a determining unit, configured to obtain a total stay time for the vehicle model area by summing up the accumulated stay time of the vehicle model area in at least one the preset time period within the preset time range.

Further, the controlling unit is also configured to:

in response to that the preset time period is expired, reset the accumulator.

In some embodiments, the apparatus further includes:

a receiving and processing module 50, configured to receive from the terminal, a first query condition which at least includes the preset time range.

The second determining module 20 is further configured to:

in response to the first query condition, determine the total stay time for each of the plurality of vehicle models based on captured images involving a plurality of target persons visited within the preset time range.

Those skilled in the art should understand that the implementation functions of each processing module in the data processing apparatus shown in FIG. 4 can be understood with reference to the relevant description of the aforementioned data processing method. Those skilled in the art should understand that the function of each processing unit in the data processing apparatus shown in FIG. 4 can be implemented by a program running on a processor, or can be implemented by a specific logic circuit.

In practical applications, the above-mentioned specific structures of the first determining module 10, the second determining module 20, the sending and processing module 30, the third determining module 40, and the receiving and processing module 50 can all correspond to processors. The specific structure of the processor may be a central processing unit (CPU), a micro controller unit (MCU), a digital signal processor (DSP), or a programmable logic controller (PLC) and other electronic components or a combination of electronic components with processing functions. The processor includes executable code storing in a storage medium, and the processor can be connected to the storage medium through a communication interface such as a bus. When the corresponding functions of specific units are performed, the executable code is read from the storage medium and run by the processor. The part of the storage medium for storing the executable code may be a non-transitory storage medium.

The data processing apparatus provided by the embodiments of the present disclosure can determine the popularity of each vehicle model based on the total stay time of the target person on the vehicle model, which is beneficial for the staff to perform targeted work and offer services according to the popularity of the vehicle model, thereby improving customer experience and sales conversion rate.

The embodiment of the present application also provides a data processing apparatus. The apparatus includes a memory, a processor, and a computer program stored in the memory and can be run on the processor. The processor implements any of the data processing methods provided by the technical solutions when the program is executed.

In an embodiment, upon executing the program, the processor implements:

determining a total stay time for each of a plurality of vehicle models based on captured images involving a plurality of target persons visited within a preset time range;

determining a popularity ranking result for the plurality of vehicle models based on the total stay time for each of the plurality of vehicle models; and

sending the popularity ranking result for the plurality of vehicle models to a terminal.

In an embodiment, upon executing the program, the processor implements:

for each of the target persons, determining an interested vehicle model based on stay time information on the target person for the plurality of vehicle models.

In an embodiment, upon executing the program, the processor implements:

based on location information on a target person which is involved in the captured images and location information on one or more vehicle model areas which are preset for each of the plurality of vehicle models, determining a vehicle model area where the target person stay; and

based on a capturing timing of each of the captured images and the vehicles model areas where the target person involved in the captured images stays, determining a stay time of the target person for each of the plurality of vehicle models.

In an embodiment, upon executing the program, the processor implements:

in response to that adjacent appearances of the target persons correspond to a same vehicle model area and a time difference between the adjacent appearances is less than or equal to a preset time threshold, counting the time difference between the adjacent appearances into stay time of the target persons for the corresponding vehicle model area.

In an embodiment, upon executing the program, the processor implements:

in response to that a time difference between adjacent appearances of the target persons is greater than a preset time threshold, determining not to count the time difference between the adjacent appearances into stay time of the target persons for the corresponding vehicle model area.

In an embodiment, upon executing the program, the processor implements:

configuring an independent accumulator for each of a plurality of vehicle model areas corresponding to the plurality of vehicle models;

with a preset time period as a unit, obtaining an accumulated stay time of the vehicle model area in the preset time period by accumulating stay time of the target persons appearing in the vehicle model area through the accumulator; and

for at least one preset time period within the preset time range, obtaining the total stay time corresponding to the vehicle model area by summing up the accumulated stay time for the vehicle model area.

In an embodiment, upon executing the program, the processor implements:

in response to that the preset time period is expired, resetting the accumulator.

In an embodiment, upon executing the program, the processor implements:

receiving, from the terminal, a first query condition which at least includes the preset time range; and

in response to the first query condition, determining the total stay time for each of the plurality of vehicle models based on captured images involving a plurality of target persons visited within the preset time range.

The data processing apparatus provided by the embodiments of the present disclosure can determine the popularity of each vehicle model based on the stay time of the target person in the vehicle model area, which is beneficial for the staff to perform targeted work and offer services according to the popularity of the vehicle model, thereby improving customer experience and sales conversion rate.

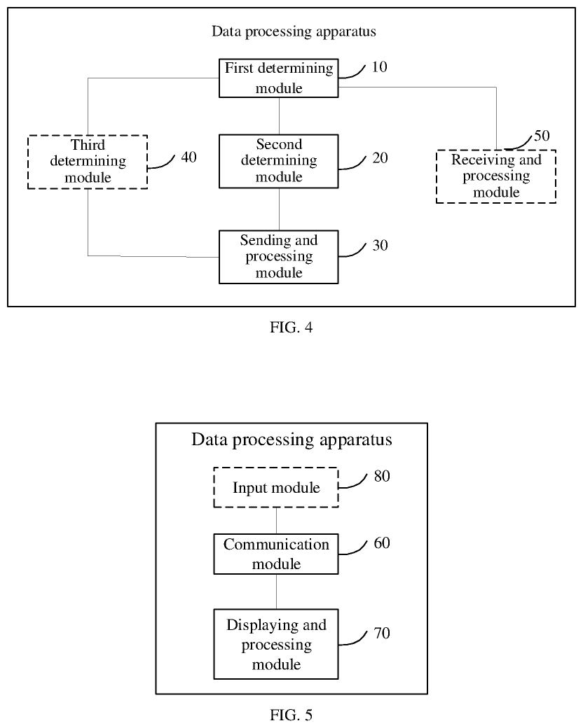

Corresponding to the foregoing data processing method, an embodiment of the present disclosure provides a data processing apparatus. As shown in FIG. 5, the apparatus includes:

a communication module 60, configured to receive a popularity ranking result for a plurality of vehicle models from a server;

a displaying and processing module 70, configured to display the popularity ranking result for the plurality of vehicle models; and

a popularity of each of the vehicle models is obtained by the server based on a total stay time for each of the plurality of vehicle models within a preset time range.

In some embodiments, the apparatus further includes:

an input module 80, configured to receive a first query condition which at least includes the preset time range;

and the communication module 60 is further configured to send the first query condition to the server.

Those skilled in the art should understand that the implementation functions of each processing module in the data processing apparatus shown in FIG. 5 can be understood with reference to the relevant description of the aforementioned data processing method. Those skilled in the art should understand that the function of each processing unit in the data processing apparatus shown in FIG. 5 can be implemented by a program running on a processor, or can be implemented by a specific logic circuit.

In practical applications, the specific structures of the aforementioned communication module 60, display processing module 70, and input module 80 can all correspond to processors. The specific structure of the processor may be an electronic component or a combination of electronic components with processing functions such as CPU, MCU, DSP or PLC. The processor includes executable code storing in a storage medium, and the processor can be connected to the storage medium through a communication interface such as a bus. When the corresponding functions of specific units are performed, the executable code is read from the storage medium and run by the processor. The part of the storage medium for storing the executable code may be a non-transitory storage medium.

The data processing apparatus provided by the embodiments of the present disclosure can provide the popularity ranking for the vehicle models matched with the query condition to the terminal, so that the staff may perform targeted works and offer services based on the popularity of the vehicle models and the customer experience and sales conversion rate may be improved.

The embodiment of the present application also provides a data processing apparatus. The apparatus includes a memory, a processor, and a computer program stored in the memory and can be run on the processor. The processor implements any of the data processing methods provided by the technical solutions when the program is executed.

In an embodiment, upon executing the program, the processor implements:

receiving a popularity ranking result for a plurality of vehicle models from a server;

displaying the popularity ranking result for the plurality of vehicle models; and

a popularity of each of the vehicle models is obtained by the server based on a total stay time for each of the plurality of vehicle models within a preset time range.

In an embodiment, upon executing the program, the processor implements:

receiving a first query condition, where the first query condition at least includes the preset time range; and

sending the first query condition to the server.

Those skilled in the art should understand that the implementation functions of each processing module in the data processing apparatus shown in FIG. 5 can be understood with reference to the relevant description of the aforementioned data processing method. Those skilled in the art should understand that the function of each processing unit in the data processing apparatus shown in FIG. 5 can be implemented by a program running on a processor, or can be implemented by a specific logic circuit.

The data processing apparatus provided by the embodiments of the present disclosure can provide the popularity ranking for the vehicle models matched with the query condition to the terminal, so that the staff may perform targeted works and offer services based on the popularity of the vehicle models and the customer experience and sales conversion rate may be improved.

The embodiments of the present disclosure also provide a computer storage medium in which computer-executable instructions are stored, and the computer-executable instructions are used to execute the data processing methods applied to a server in each of the foregoing embodiments. In other words, when the computer-executable instructions are executed by the processor, the data processing method applied to the server provided by any of the foregoing technical solutions can be implemented.

Those skilled in the art should understand that the functions of each program in the computer storage medium of this embodiment can be understood with reference to the relevant description of the data processing method applied to the server in the foregoing embodiments.

The embodiments of the present disclosure also provide a computer storage medium in which computer-executable instructions are stored, and the computer-executable instructions are used to execute the data processing methods applied to a terminal in each of the foregoing embodiments. In other words, when the computer-executable instructions are executed by the processor, the data processing method applied to the terminal provided by any of the foregoing technical solutions can be implemented.

Those skilled in the art should understand that the functions of each program in the computer storage medium of this embodiment can be understood with reference to the relevant description of the data processing method applied to the terminal in the foregoing embodiments. The computer storage medium may be a volatile computer-readable storage medium or a non-volatile computer-readable storage medium.

The embodiments of the present disclosure also provide a computer program product, which includes computer readable code. When the computer-readable code is run on a device, a processor in the device may execute the data processing method provided in any of the above embodiments.

The above-mentioned computer program product can be specifically implemented by hardware, software or a combination thereof. In an embodiment, the computer program product is specifically embodied as a computer storage medium. In another optional embodiment, the computer program product is specifically embodied as a software product, such as a software development kit (SDK), etc.

Those skilled in the art should understand that the functions of each program in the computer storage medium of this embodiment can be understood with reference to the relevant description of the data processing method described in the foregoing embodiments.

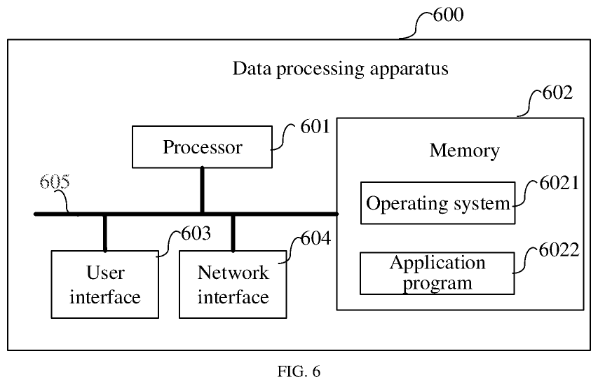

FIG. 6 is a structural schematic diagram of an data processing apparatus 600 of another embodiment of the present disclosure. The data processing apparatus 600 may be a mobile phone, a computer, a digital broadcast terminal, a transceiver, a gaming console, a tablet device, a medical device, a fitness equipment, a personal digital assistant, etc. The data processing apparatus 600 shown in FIG. 6 includes: at least one processor 601, a memory 602, at least one network interface 604, and a user interface 603. The various components in the data processing apparatus 600 are coupled together through a bus system 605. It can be understood that the bus system 605 is used to implement connection and communication between the components. In addition to the data bus, the bus system 605 also includes a power bus, a control bus, and a status signal bus. However, for clarity of description, various buses are all marked as the bus system 605 in FIG. 6.

The user interface 603 may include a display, a keyboard, a mouse, a trackball, a click wheel, keys, buttons, a touch panel, or a touch screen.

It can be understood that the memory 602 may be a volatile memory or a non-volatile memory, and may also include both volatile and non-volatile memory. The non-volatile memory can be a read-only memory (ROM), a programmable read-only memory (PROM), and an erasable programmable read-only memory (EPROM), an electrically erasable programmable read-only memory (EEPROM), a ferromagnetic random access memory (FRAM), a flash memory, a magnetic surface memory, optical disk, or a compact disc read-only memory (CN-ROM); where the magnetic surface memory can be disk memory or tape memory. The volatile memory may be a random access memory (RAM), which is used as an external cache. By way of exemplary but not restrictive description, many forms of RAM are available, such as static random access memory (SRAM), synchronous static random access memory (SSRAM), and dynamic random access memory (DRAM), synchronous dynamic random access memory (SDRAM), double data rate synchronous dynamic random access memory (DDRSDRAM), enhanced synchronous dynamic random access memory (ESDRAM), sync link dynamic random access memory (SLDRAM), and direct Rambus random access memory (DRRAM). The memory 602 described in the embodiment of the present disclosure is intended to include, but is not limited to, these and any other suitable types of memory.

The memory 602 in the embodiment of the present disclosure is used to store various types of data to support the operation of the data processing apparatus 600. Examples of these data include: any computer program used to operate on the data processing apparatus 600, such as an operating system 6021 and an application program 6022; contact data, contact data, messages, pictures, videos, etc. The operating system 6021 includes various system programs, such as a framework layer, a core library layer, a driver layer, etc., for implementing various basic services and processing hardware-based tasks. The application program 6022 may include various application programs, such as a media player, a browser, etc., for implementing various application services. The program for implementing the methods of the embodiments of the present disclosure may be included in the application program 6022.

The method disclosed in the foregoing embodiments of the present disclosure may be applied to the processor 601 or implemented by the processor 601. The processor 601 may be an integrated circuit chip with signal processing capability. In the implementation process, the steps of the foregoing method can be completed by hardware integrated logic circuits in the processor 601 or instructions in the form of software. The processor 601 may be a general-purpose processor, a digital signal processor (DSP), or other programmable logic component, a discrete gate or a transistor logic component, a discrete hardware component, and the like. The processor 601 may implement or execute various methods, steps, and logical block diagrams disclosed in the embodiments of the present disclosure. The general-purpose processor may be a microprocessor or any conventional processor. The steps of the methods disclosed in the embodiments of the present disclosure can be directly embodied as being executed and completed by a hardware decoding processor, or executed and completed by a combination of hardware and software modules in the decoding processor. The software module may be located in a storage medium, and the storage medium is located in the memory 602. The processor 601 reads the information in the memory 602 and completes the steps of the foregoing methods in combination with the hardware.

In an embodiment, the data processing apparatus 600 may be implemented by one or more application specific integrated circuit (ASIC), demand side platform (DSP), programmable logic device (PLD), complex programmable logic device (CPLD), field-programmable gate array (FPGA), general-purpose processor, controller, micro controller unit (MCU), microprocessor, or other electronic component to perform the aforementioned methods.

In the several embodiments provided in the present disclosure, it should be understood that the disclosed apparatuses and methods may be implemented in other ways. The apparatus embodiments described above are merely schematic, for example, the division of the units is merely a logical function division, and there may be another division manner in actual implementation, for example, a plurality of units or components may be combined, or may be integrated into another system, or some features may be ignored or not performed. Moreover, the coupling, or direct coupling, or communication connection between the components shown or discussed may be through some interfaces, indirect coupling or communication connection of components or units, and may be electrical, mechanical, or other forms.

The units described as separate components may or may not be physically separate, and the components displayed as units may or may not be physical units. Not only may be located in one place, but also may be distributed to a plurality of network units. Some or all of the units may be selected according to actual needs to achieve the purpose of the solution of the present disclosure.

In addition, all the functional units in the embodiments of the present disclosure may be integrated into one processing unit, or each unit separately serves as one unit, or two or more units may be integrated into one unit. The integrated units may be implemented in the form of hardware or in the form of hardware and software function units.

Persons of ordinary skill in the art may understand that all or part of the steps of the foregoing method embodiments may be implemented by a program instructing relevant hardware. The foregoing program may be stored in a computer readable storage medium. When the program is executed, the steps of the foregoing method embodiments are performed. The foregoing storage medium includes a removable storage device, a ROM, a RAM, a magnetic disk, an optical disk, and any other medium that can store program codes.

Alternatively, if the integrated unit of the present application is implemented in the form of a software function module and sold or used as an independent product, the integrated unit may also be stored in a computer readable storage medium. Based on such understanding, the technical solutions of the embodiments of the present application can be embodied in the form of a software product essentially or in part that makes a contribution to the prior art. The computer software product is stored in a storage medium. Several instructions are included to cause a computer device (which may be a personal computer, a server, or a network device) to perform all or part of the method described in each embodiment of the present disclosure. The foregoing storage medium includes various media that can store program codes, such as a removable storage device, a ROM, a RAM, a magnetic disk, or an optical disk.

The above are merely specific embodiments of the present disclosure, but the scope of protection of the present application is not limited thereto, and any variation or replacement readily conceivable by a person skilled in the art within the technical scope disclosed in the present application should be covered within the scope of protection of the present application. Therefore, the scope of protection of the present disclosure should be based on the scope of protection of said claims.

### INDUSTRIAL APPLICABILITY

In the technical solution of the embodiments, a total stay time for each of the plurality of vehicle models is determined based on the captured images involving a plurality of target persons visited within the preset time range; a popularity ranking result for the plurality of vehicle models is determined based on the total stay time for each of the plurality of vehicle models; and the popularity ranking result for the plurality of vehicle models is sent to a terminal. As such, by determining the popularity ranking for the vehicle models based on the stay time of the target person in the vehicle model area, the staff may perform targeted works and offer services based on the popularity of the vehicle models and the customer experience and sales conversion rate may be improved.

1. A data processing method, being applicable to a server, comprising:
determining a total stay time for each of a plurality of vehicle models based on captured images involving a plurality of target persons visited within a preset time range;
determining a popularity ranking result for the plurality of vehicle models based on the total stay time for each of the plurality of vehicle models; and
sending the popularity ranking result for the plurality of vehicle models to a terminal.

2. The method of claim 1, further comprising:
for each of the target persons, determining an interested vehicle model based on stay time information on the target person for the plurality of vehicle models.

3. The method of claim 1, wherein determining the total stay time for each of the plurality of vehicle models comprises:
based on location information on a target person which is involved in the captured images and location information on one or more vehicle model areas which are preset for each of the plurality of vehicle models, determining a vehicle model area where the target person stay; and
based on a capturing timing of each of the captured images and the vehicles model areas where the target person involved in the captured images stays, determining a stay time of the target person for each of the plurality of vehicle models.

4. The method of claim 3, wherein determining the total stay time for each of the plurality of vehicle models comprises:
in response to that adjacent appearances of a target person correspond to a same vehicle model area and a time difference between the adjacent appearances is less than or equal to a preset time threshold, counting the time difference between the adjacent appearances into the stay time of the target person for the corresponding vehicle model area.

5. The method of claim 3, wherein determining the total stay time for each of the plurality of vehicle models comprises:
in response to that a time difference between adjacent appearances of a target person is greater than a preset time threshold, determining not to count the time difference between the adjacent appearances into the stay time of the target person for the corresponding vehicle model area.

6. The method of claim 1, wherein determining the total stay time for each of the plurality of vehicle models based on the captured images involving the plurality of target persons visited within the preset time range comprises:
for each of a plurality of vehicle model areas corresponding to the plurality of vehicle models,
configuring an independent accumulator for the vehicle model area;
accumulating, at a preset time period and by the accumulator, a stay time of target persons appeared in the vehicle model area, so as to obtain an accumulated stay time of the vehicle model area in the preset time period; and
obtaining a total stay time for the vehicle model area by summing up the accumulated stay time of the vehicle model area in at least one the preset time period within the preset time range.

7. The method of claim 6, further comprising:
in response to that the preset time period is expired, resetting the accumulator.

8. The method of any of claim 1,
wherein the method further comprises:
receiving, from the terminal, a first query condition which at least comprises the preset time range; and
wherein determining the total stay time for each of the plurality of vehicle models based on the captured images involving the plurality of target persons visited within the preset time range comprises:
in response to the first query condition, determining the total stay time for each of the plurality of vehicle models based on the captured images involving the plurality of target persons visited within the preset time range.

9. A data processing method, being applicable to a terminal, comprising:
receiving a popularity ranking result for a plurality of vehicle models from a server; and
displaying the popularity ranking result for the plurality of vehicle models;
wherein, a popularity of each of the vehicle models is obtained by the server based on a total stay time for each of the plurality of vehicle models within a preset time range.

10. The method of claim 9, further comprising:
receiving a first query condition which at least comprises the preset time range; and
sending the first query condition to the server.

11. The method of claim 9, further comprising:
receiving a second query condition which at least comprises an identification of a first target person; and
sending the second query condition to the server to determine, by the server, an interested vehicle model of the first target person according to the second query condition.

12. The method of claim 11, wherein the identification comprises one of the following:
an ID card number, a mobile phone number, and a WeChat ID.

13. The method of claim 11, wherein the identification comprises an image containing a facial feature or a body feature of the first target person.

14. The method of claim 11, further comprising:
receiving the interested vehicle model of the first target person from the server; and
displaying the interested vehicle model of the first target person.

15. A data processing apparatus comprising: a memory, a processor and a computer program stored on the memory and executable by the processor, when the program is executed by the processor, the processor performs the following operations:
determining a total stay time for each of a plurality of vehicle models based on captured images involving a plurality of target persons visited within a preset time range;
determining a popularity ranking result for the plurality of vehicle models based on the total stay time for each of the plurality of vehicle models; and
sending the popularity ranking result for the plurality of vehicle models to a terminal.

16. The apparatus of claim 15, wherein determining the total stay time for each of the plurality of vehicle models comprises:
based on location information on a target person which is involved in the captured images and location information on one or more vehicle model areas which are preset for each of the plurality of vehicle models, determining a vehicle model area where the target person stay; and
based on a capturing timing of each of the captured images and the vehicles model areas where the target person involved in the captured images stays, determining a stay time of the target person for each of the plurality of vehicle models.

17. The apparatus of claim 15, determining the total stay time for each of the plurality of vehicle models based on the captured images involving the plurality of target persons visited within the preset time range comprises:
for each of a plurality of vehicle model areas corresponding to the plurality of vehicle models,
configuring an independent accumulator for the vehicle model area;
accumulating, at a preset time period and by the accumulator, a stay time of target persons appeared in the vehicle model area, so as to obtain an accumulated stay time of the vehicle model area in the preset time period; and
obtaining a total stay time for the vehicle model area by summing up the accumulated stay time of the vehicle model area in at least one the preset time period within the preset time range.

18. The apparatus of claim 15,
wherein the processor further performs the following operations:
receiving, from the terminal, a first query condition which at least comprises the preset time range; and
wherein determining the total stay time for each of the plurality of vehicle models based on the captured images involving the plurality of target persons visited within the preset time range comprises:
in response to the first query condition, determining the total stay time for each of the plurality of vehicle models based on the captured images involving the plurality of target persons visited within the preset time range.

19. A non-transitory computer readable storage medium storing a computer program, when the computer program is executed by a processor, the processor implements the data processing method of claim 1.

20. A computer program comprising computer readable codes, wherein when the computer readable codes are run in an electronic device, a processor in the electronic device implements the data processing method of claim 1.
